(19) United States
(12) Patent Application Publication
(10) Pub. No.: US 2009/0124227 A1
(43) Pub. Date: May 14, 2009

(54) AUTOMATIC GAIN CONTROL CIRCUIT

(76) Inventor: Kazuhisa ISHIGURO, Ota-shi (JP)

Correspondence Address: SMITH PATENT OFFICE, 1901 PENNSYLVANIA AVENUE N W, SUITE 901, WASHINGTON, DC, 20006, US

(21) Appl. No.: 12/266,616

(22) Filed: Nov. 7, 2008

(30) Foreign Application Priority Data
Nov. 9, 2007 (JP) 2007-292499

(51) Int. Cl. H04B 1/06

(52) U.S. Cl. 455/249.1

(57) ABSTRACT

A first signal path including a first LNA 3 and a second signal path including an antenna damping circuit 4 and a second LNA 5 are connected in parallel, and switching into either the first signal path or the second signal path is carried out to control a gain of a received signal. When a level of the received signal is higher than a first threshold, it is once attenuated by the antenna damping circuit 4 and is then amplified by a necessary quantity through the second LNA 5. Thus, the gain of the received signal is controlled in a total of the attenuation and the amplification. Consequently, a level of a signal to be input to the second LNA 5 is reduced to cause a distortion of the signal in the amplification with difficulty.

### FIELD OF THE INVENTION

The present invention relates to an automatic gain control circuit, and more particularly to an automatic gain control circuit including a radio frequency amplifier and an attenuator which have variable gains and carrying out an AGC operation for suppressing a distortion of a signal when a signal having a high level is input to a wireless communicating apparatus such as a radio receiver.

### DESCRIPTION OF THE RELATED ART

A wireless communicating apparatus such as a radio receiver is usually provided with an AGC (Automatic Gain Control) circuit for controlling a gain of a received signal. An RF (Radio Frequency)-AGC circuit controls a gain of a radio frequency signal (an RF signal) received by an antenna and maintains a level of the received signal to be constant. The RF-AGC can be implemented by controlling a quantity of an attenuation of a signal level in an antenna damping circuit or a quantity of an amplification of the signal level in an LNA (Low Noise Amplifier) or the like.

The RF-AGC circuit is not operated when an electric field strength of the received signal is not greater than a threshold, and does not reduce a gain of the received signal. More specifically, the RF-AGC circuit amplifies the received signal with a maximum gain of the LNA and outputs the signal thus amplified. When a signal having a strong electric field is input to the antenna so that the electric field strength exceeds the threshold, however, the RF-AGC circuit is operated to reduce the gain of the received signal (to reduce an amplification gain of the LNA in response to a level of the received signal or to attenuate a signal level through the antenna damping circuit), thereby suppressing an occurrence of a distortion in the received signal.

In general, the wireless communicating apparatus includes the LNA in an antenna input stage and further includes circuits such as a mixer, a BPF, an IF amplifier and a demodulating circuit in a plurality of subsequent stages thereto. A noise (a distortion of a signal) is made in the circuit in each stage. When a gain of the LNA positioned in an initial stage of the wireless communicating apparatus is increased, however, an influence of noise factors of the circuits connected in subsequent stages thereto is reduced so that the noise factor of the LNA is predominant over a whole noise factor. When the gain of the LNA is set to be great, however, there is a drawback that a distortion characteristic is deteriorated due to a limitation of a dynamic range of the LNA or the like.

In order to avoid the drawback, there has been proposed a technique for providing a bypass switch of an LNA to carry out switching for using or bypassing the LNA corresponding to a level of a received signal (for example, see Patent Documents 1 and 2). In the technique described in the Patent Documents 1 and 2, an attenuator (an antenna damping circuit) and an LNA are connected in parallel and either of the antenna damping circuit and the LNA can be selected and used.

[Patent Document 1] Japanese Laid-Open Patent Publication No. 9-72955

[Patent Document 2] Japanese Laid-Open Patent Publication No. 10-327091

In the prior art described in the Patent Documents 1 and 2, however, a switch is connected in series to a parallel circuit constituted by the antenna damping circuit and the LNA. For this reason, there is a problem in that a noise factor of the LNA is deteriorated due to an ON resistance of the switch and a desirable input sensitivity cannot be obtained in an operation of the LNA. In order to solve the problem, the present applicant invented an RF-AGC circuit in which an antenna damping circuit and a bypass switch are connected in series and the series circuit and an LNA are connected in parallel, and filed the patent application (Patent Document 3).

[Patent Document 3] Japanese Patent Application No. 2006-118745

FIG. 5 is a diagram showing a structure of the RF-AGC circuit described in the Patent Document 3. In FIG. 5, an LNA 101 amplifies a radio frequency signal received by an antenna with a low noise in accordance with a gain which is variably set in response to a first AGC signal. An antenna damping circuit 102 controls the radio frequency signal received by the antenna to have a degree of an attenuation which is variably set in response to a second AGC signal. A bypass switch 103 is connected in series to the antenna damping circuit 102.

Moreover, an input node of the LNA 101 is connected to that of the antenna damping circuit 102, and an output node of the LNA 101 is connected to that of the bypass switch 103. Consequently, the LNA 101 and a series circuit constituted by the antenna damping circuit 102 and the bypass switch 103 are connected in parallel. When the bypass switch 103 is ON, only the antenna damping circuit 102 is used for a gain control (the LNA 101 is turned OFF). When the bypass switch 103 is OFF, only the LNA 101 is used for the gain control.

For example, if an operation area of the LNA 101 is 0 to 20 [dB] and that of the antenna damping circuit 102 is −20 to 0 [dB], the whole RF-AGC circuit has an AGC range of 40 [dB]. In this case, when a received signal is set to be variable within a range of a level of 0 [dB] or more, the LNA 101 is used to control the gain of the LNA 101 based on the first AGC signal. On the other hand, when the received signal is set to be variable within a range of a lower level than 0 [dB], the antenna damping circuit 102 is used to control a quantity of an attenuation of the antenna damping circuit 102 based on the second AGC signal.

FIG. 6 is a chart showing a relative relationship between a level of a signal input to the RF-AGC circuit and that of a signal output therefrom. As shown in FIG. 6, in a region in which a level Vi of a received signal to be input to the RF-AGC circuit is lower than a predetermined threshold, an AGC operation is not carried out but the received signal is amplified with the maximum gain of the LNA 101 and the signal thus amplified is output. Therefore, the input signal level Vi of the RF-AGC circuit and an output signal level Vo have an almost proportional relationship.

On the other hand, in a region in which the level Vi of the received signal is higher than the predetermined threshold, the AGC operation is carried out and a gain for the received signal is controlled by the LNA 101 and the antenna damping circuit 102 in such a manner that the output signal level Vo is almost constant even if the input signal level Vi of the RF-AGC circuit is increased. FIG. 6 shows a characteristic in the case in which two thresholds VA and VB are assumed as thresholds for determining a boundary for an execution of the AGC operation with respect to the level Vi of the received signal, that is, a level of the received signal which starts the AGC operation (which will be hereinafter referred to as an “AGC starting level”).

### DISCLOSURE OF THE INVENTION

The AGC circuit shown in FIG. 5 is effective for reducing a level of a disturbing wave included in a received signal. For example, when a strong disturbing wave enters, a gain of the received signal is reduced so that a signal level of the disturbing wave can be decreased. However, the received signal to be a target for reducing a gain includes a signal having a desirable frequency in addition to the signal of the disturbing wave which makes a noise. Accordingly, if the AGC circuit is operated when the signal having the desirable frequency has a low level, the level of the signal having the desirable frequency which is originally low is reduced still more. As a result, there is a problem in that a suppression in a sensitivity is caused, for example, a receiving sensitivity of a desirable station is remarkably reduced.

In order to avoid the problem of the suppression in a sensitivity, it is necessary to increase the AGC starting level (for example, the threshold VB which is greater in the example of FIG. 6 is used as the AGC starting level). When the AGC starting level is increased, however, a received signal having a level exceeding the dynamic range of the LNA 101 is input to the LNA 101. For this reason, a distortion characteristic of the signal, particularly, an intermodulation distortion characteristic is deteriorated. In other words, there is a problem in that the suppression in a sensitivity is caused when the AGC starting level is reduced, and the distortion characteristic is deteriorated when the AGC starting level is increased.

In order to solve the problems, it is an object of the present invention to cause an improvement in a suppression in a sensitivity and an improvement in a distortion characteristic to be compatible with each other in the case in which an AGC operation is carried out.

In order to attain the object, in the present invention, a first signal path including a first radio frequency amplifying circuit and a second signal path including a series circuit constituted by a variable attenuating circuit and a second radio frequency amplifying circuit are connected in parallel, and switching into either the first signal path or the second signal path is carried out to control a gain of a received signal. More specifically, the gain of the received signal is controlled by using the first signal path when a level of the received signal is equal to or lower than a predetermined threshold and using the second signal path when the level of the received signal is higher than the predetermined threshold.

According to the present invention having the structure described above, when the level of the received signal is equal to or lower than the predetermined threshold, an amplification gain of the first radio frequency amplifying circuit included in the first signal path is reduced so that the gain of the received signal is controlled. When the level of the received signal is higher than the predetermined threshold, the level of the received signal is once attenuated by the variable attenuating circuit included in the second signal path and the level of the received signal is then amplified by a necessary quantity through the second radio frequency amplifying circuit. Consequently, the gain of the received signal is controlled in a total of the attenuation and the amplification.

In general, the greater the level of the received signal, the easier a distortion occurs in the signal if the level is simply amplified by the radio frequency amplifying circuit. On the other hand, according to the present invention, when the level of the received signal is higher than the predetermined threshold, it is attenuated by the variable attenuating circuit and is then amplified by the necessary quantity through the second radio frequency amplifying circuit. Therefore, the level of the signal to be input to the second radio frequency amplifying circuit is comparatively reduced. Even if the signal is amplified, the distortion of the signal occurs with difficulty. consequently, in the case in which the AGC starting level is increased to inhibit the suppression in a sensitivity, it is possible to suppress a deterioration in the distortion characteristic when a received signal having a high level is input. Thus, it is possible to cause an improvement in the suppression in a sensitivity and an improvement in the distortion characteristic to be compatible with each other.

### BRIEF DESCRIPTION OF THE DRAWINGS

FIG. 1 is a diagram showing an example of a whole structure of an automatic gain control circuit (an RF-AGC circuit) and a radio receiver applying the RF-AGC circuit according to a first embodiment,

FIG. 2 is a diagram showing an example of a structure of a first LNA according to the present embodiment,

FIG. 3 is a diagram showing an example of a structure of an RF-AGC circuit according to a second embodiment,

FIG. 4 is a diagram showing an example of a structure of an RF-AGC circuit according to a third embodiment,

FIG. 5 is a diagram showing an example of a structure of a conventional RF-AGC circuit, and

FIG. 6 is a chart showing a relative relationship between a level of a signal input to the conventional RF-AGC circuit and a level of a signal output therefrom.

### BEST MODE FOR CARRYING OUT THE INVENTION

### First Embodiment

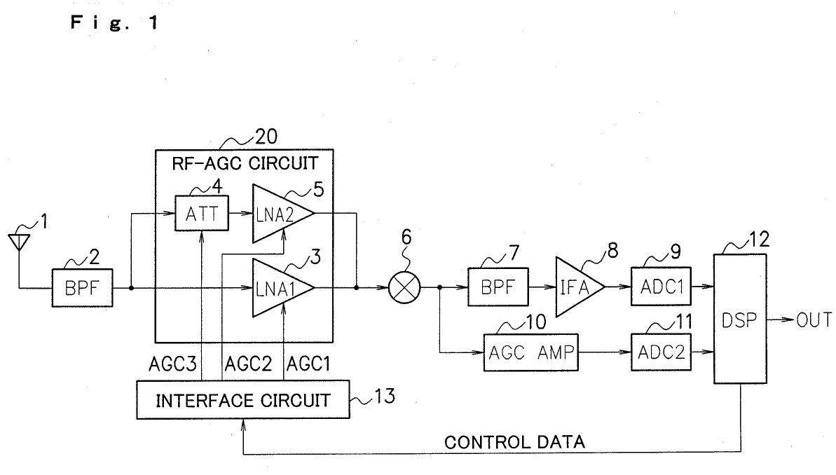

An embodiment according to the present invention will be described below with reference to the drawings. FIG. 1 is a diagram showing an example of a whole structure of an automatic gain control circuit (an RF-AGC circuit 20) and a radio receiver applying the RF-AGC circuit 20 according to a first embodiment.

As shown in FIG. 1, the radio receiver according to the present embodiment is constituted by an antenna 1, a band-pass filter (BPF) 2, a first LNA 3, an antenna damping circuit 4, a second LNA 5, a frequency converting circuit 6, a BPF 7, an IF amplifier 8, a first A/D converting circuit 9, an AGC amplifier 10, a second A/D converting circuit 11, a DSP (Digital Signal Processor) 12, and an interface circuit 13. These structures (excluding the antenna 1) are integrated into a single semiconductor chip through a CMOS (Complementary Metal Oxide Semiconductor) process, for example.

The BPF 2 selectively outputs a broadcast wave signal of a specific frequency band from broadcast wave signals received by the antenna 1. The BPF 2 has a comparatively broad pass band and causes a broadcast signal including a desirable frequency band to pass therethrough. The first LNA 3 corresponds to a first radio frequency amplifying circuit according to the present invention and amplifies a radio frequency signal passing through the BPF 2 with a low noise. A gain of the first LNA 3 is variably set in response to a first AGC signal supplied from the interface circuit 13.

The antenna damping circuit 4 corresponds to a variable attenuating circuit according to the present invention and controls the radio frequency signal passing through the BPF 2 to have a degree of an attenuation which is variably set in response to a third AGC signal supplied from the interface circuit 13. The antenna damping circuit 4 according to the present embodiment is constituted by a variable resistor circuit, for example. The variable resistor circuit includes N (N is an integer of two or more) resistor elements and N switches for selecting any of the N resistor elements. Resistance values of the N resistor elements are different from each other. Any of the N switches to be turned ON is controlled in response to the third AGC signal supplied from the interface circuit 13. In the antenna damping circuit 4 thus constituted, it is possible to vary a quantity of the attenuation by turning ON any of the N switches.

The second LNA 5 corresponds to a second radio frequency amplifying circuit according to the present invention and is connected in series to the antenna damping circuit 4. The second LNA 5 amplifies a radio frequency signal output from the antenna damping circuit 4 with a low noise in accordance with a gain which is variably set based on a second AGC signal supplied from the interface circuit 13.

The RF-AGC circuit 20 according to the first embodiment is constituted by the first LNA 3, the antenna damping circuit 4 and the second LNA 5. As shown in FIG. 1, the RF-AGC circuit 20 according to the first embodiment has a first signal path including the first LNA 3 and a second signal path including the antenna damping circuit 4 and the second LNA 5, and both of the signal paths are connected in parallel. More specifically, an input node of the first LNA 3 is connected to that of a series circuit constituted by the antenna damping circuit 4 and the second LNA 5, and an output node of the first LNA 3 is connected to that of the series circuit. Consequently, the first signal path including the first LNA 3 and the second signal path including the series circuit constituted by the antenna damping circuit 4 and the second LNA 5 are connected in parallel.

In the RF-AGC circuit 20 having the first signal path and the second signal path, a gain of a radio frequency signal received by the antenna 1 is controlled by using the first signal path when a level of the radio frequency signal is equal to or lower than a first threshold and using the second signal path when the level of the radio frequency signal is higher than the first threshold. In the case in which the level of the radio frequency signal is equal to or lower than an AGC starting level which is lower than the first threshold, an AGC operation is not carried out. On the other hand, the AGC operation is carried out through the first signal path when a level of a received signal is higher than the AGC starting level and is equal to or lower than the first threshold, and the AGC operation is carried out through the second signal path when the level of the received signal is higher than the first threshold.

For example, when both dynamic ranges of the first LNA 3 and the second LNA 5 are 20 [dB] and an AGC range in the whole RF-AGC circuit 20 is 40 [dB] of −20 to 20 [dB], an operation area of the first signal path is set to be 10 to 20 [dB] and that of the second signal path is set to be −20 to 10 [dB]. More specifically, when the level of the radio frequency signal received by the antenna 1 is equal to or lower than the first threshold and the radio frequency signal is amplified within a range of 10 to 20 [dB], the first signal path is used. On the other hand, when the level of the radio frequency signal received by the antenna 1 is higher than the first threshold, and the radio frequency signal is amplified within a range of 0 to 10 [dB] and is attenuated within a range of −20 to 0 [dB], the second signal path is used.

For example, when the received radio frequency signal is amplified by 5 [dB], it is attenuated by −10 [dB] through the antenna damping circuit 4, for example, and is then amplified by 15 [dB] through the second LNA 5. Consequently, the radio frequency signal is amplified by 5 [dB] in a total of the attenuation and the amplification. When the received radio frequency signal is to be attenuated by −10 [dB], moreover, it is attenuated by −10 [dB] through the antenna damping circuit 4, for example, and is not amplified through the second LNA 5 (an amplification gain is set to be 0 [dB]). Consequently, the radio frequency signal is attenuated by −10 [dB] in the total of the attenuation and the amplification.

The radio frequency signal passing through the first signal path or the second signal path in the RF-AGC circuit 20 is supplied to the frequency converting circuit 6. The frequency converting circuit 6 mixes the radio frequency signal supplied from the RF-AGC circuit 20 with a local oscillating signal supplied from a local oscillating circuit which is not shown, and carries out a frequency conversion to generate and output an intermediate frequency signal. The BPF 7 carries out a band limitation for the intermediate frequency signal supplied from the frequency converting circuit 6 and extracts an intermediate frequency signal of a narrow band which includes only one station having a desirable frequency.

The IF amplifier 8 amplifies the intermediate frequency signal (including only a desirable wave) of the narrow band which is output from the BPF 7. The first A/D converting circuit 9 analog-digital converts the intermediate frequency signal output from the IF amplifier 8. Thus, the intermediate frequency signal thus converted into digital data is input to the DSP 12. The DSP 12 demodulates, into a baseband signal, the digital intermediate frequency signal of the narrow band which is input from the first A/D converting circuit 9 and outputs the baseband signal.

The AGC amplifier 10 amplifies an intermediate frequency signal (including both a desirable wave and a disturbing wave) of a broad band which is output from the frequency converting circuit 6. The second A/D converting circuit 11 analog-digital converts the intermediate frequency signal output from the AGC amplifier 10. The intermediate frequency signal thus converted into digital data is input to the DSP 12.

The DSP 12 detects a level of the digital intermediate frequency signal of the broad band which is input from the second A/D converting circuit 11. As described above, the digital intermediate frequency signal of the broad band includes both the desirable wave and the disturbing wave and is the same as the radio frequency signal received by the antenna 1. Accordingly, the level of the digital intermediate frequency signal of the broad band corresponds to the level of the radio frequency signal received by the antenna 1 (the level of the received signal). The DSP 12 generates control data for controlling the gains of the first LNA 3 and the second LNA 5 and the quantity of the attenuation of the antenna damping circuit 4 in response to the detected level of the received signal. Then, the control data are output to the interface circuit 13.

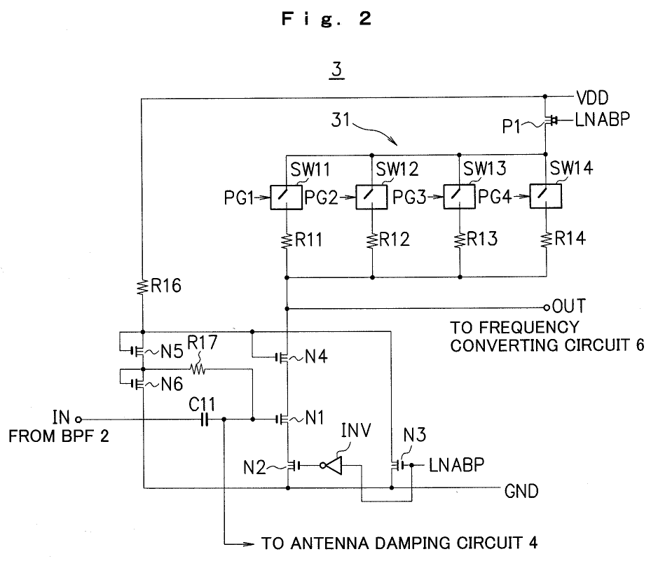

The interface circuit 13 generates the first to third AGC signals in accordance with the control data supplied from the DSP 12 and supplies them to the first LNA 3, the antenna damping circuit 4 and the second LNA 5, thereby controlling the amplification gains of the LNAs 3 and 5 and the quantity of the attenuation of the antenna damping circuit 4. Moreover, the interface circuit 13 generates a control signal LNABP (shown in FIG. 2) in accordance with the control data supplied from the DSP 12 and supplies the control signal LNABP to the LNAs 3 and 5, thereby carrying out a control to turn ON/OFF the LNAs 3 and 5.

FIG. 2 is a diagram showing an example of a structure of the first LNA 3 according to the present embodiment. Since the second LNA 5 also has the same structure, description will be omitted and only the structure of the first LNA 3 will be described. As shown in FIG. 2, the first LNA 3 includes a variable resistor circuit 31 to cause a gain to be variable. The variable resistor circuit 31 includes M (M is an integer of two or more. M is equal to four in the example of FIG. 2) resistor elements R11, R12, R13 and R14 which are connected in parallel and M (which is equal to four) switches SW11, SW12, SW13 and SW14 for selecting any of the four resistor elements R11 to R14. Resistance values of the four resistor elements R11 to R14 are different from each other. The first AGC signal supplied from the interface circuit 13 to the first LNA 3 includes control signals PG1 to PG4 for turning ON any of the switches SW11 to SW14.

The four resistor elements R11 to R14 and the four switches SW11 to SW14 are connected in series to each other and respective series circuits are connected in parallel. Consequently, one of the switches SW11 to SW14 is turned ON to select the resistor element which is to be used as a load resistor. For example, when the first switch SW11 is turned ON, the first resistor element R11 is connected as the load resistor between a power supply VDD and an output terminal OUT. When the second switch SW12 is turned ON, the second resistor element R12 is connected as the load resistor between the power supply VDD and the output terminal OUT. Thus, the gain of the first LNA 3 is caused to be variable by switching the connection of the resistor elements R11 to R14.

A pMOS transistor P1 is connected between the variable resistor circuit 31 and the power supply VDD. Moreover, a first nMOS transistor N1, a second nMOS transistor N2 and a fourth nMOS transistor N4 are connected between the variable resistor circuit 31 and a ground GND. The first nMOS transistor N1 is operated as a source grounding amplifier. The fourth nMOS transistor N4 is cascode connected to the source grounding amplifier N1 and has a drain connected to the output terminal OUT to the frequency converting circuit 6. Furthermore, the second nMOS transistor N2 is connected in series to the source grounding amplifier N1 and has a source connected to the ground GND.

The pMOS transistor P1 and the second nMOS transistor N2 control whether the first LNA 3 is bypassed or not (more specifically, carries out a control to turn ON/OFF current paths of the amplifiers N1 and N4). In order to control whether the first LNA 3 is bypassed or not, moreover, a third nMOS transistor N3 and an inverter INV are further provided. The third nMOS transistor N3 has a drain connected to a gate of the fourth nMOS transistor N4 and has a source connected to the ground GND.

The control signal LNABP output from the interface circuit 13 in FIG. 1 is applied to a gate of the pMOS transistor P1 and that of the third nMOS transistor N3, and is applied to a gate of the second nMOS transistor N2 through the inverter INV.

When the first signal path is used, the first LNA 3 is turned ON and the second LNA 5 is turned OFF. In order to turn ON the first LNA 3, the control signal LNABP is set to be a signal having a Low level. Consequently, the second nMOS transistor N2 is turned ON, the third nMOS transistor N3 is turned OFF and the pMOS transistor P1 is turned ON so that a source of the source grounding amplifier N1 is earthed into the ground GND through the second nMOS transistor N2 and a signal input from the BPF 2 is amplified by the source grounding amplifier N1. Then, the signal thus amplified is output to the frequency converting circuit 6 through the fourth nMOS transistor N4 which is cascode connected to the source grounding amplifier N1.

On the other hand, when the second signal path is used, the first LNA 3 is turned OFF and the second LNA 5 is turned ON. In order to turn OFF the first LNA 3, the control signal LNABP is set to be a signal having a High level. Consequently, the second nMOS transistor N2 is turned OFF, the third nMOS transistor N3 is turned ON and the pMOS transistor P1 is turned OFF so that the signal input from the BPF 2 is output to the frequency converting circuit 6 through the antenna damping circuit 4 and the second LNA 5.

At this time, the second nMOS transistor N2 is OFF and the third nMOS transistor N3 is ON. Therefore, a source of the source grounding amplifier N1 is brought into a floating state so that the source grounding amplifier N1 is galvanically turned OFF. The second nMOS transistor N2 is to be turned OFF because a gate-source bias is applied to the source grounding amplifier N1 so that the source grounding amplifier N1 is operated on a diode basis, resulting in a deterioration in an input dynamic range due to a nonlinear distortion of the diode. By turning OFF the second nMOS transistor N2, it is possible to avoid the drawback.

In the RF-AGC circuit 20 having the structure described above, a threshold VB which is greater in the example of FIG. 6 is used for the AGC starting level to be the threshold for starting the AGC operation, for instance. By setting the AGC starting level to have a great value, thus, it is possible to inhibit a suppression in a receiving sensitivity.

As the first threshold for determining a boundary for using the first signal path or the second signal path, a greater value than the AGC starting level (the threshold VB) is used. Consequently, the AGC operation is carried out through the first signal path when the level of the received signal is higher than the AGC starting level and is equal to or lower than the first threshold. More specifically, the gain of the received signal is controlled by a reduction in the amplification gain of the first LNA 3 included in the first signal path.

On the other hand, the AGC operation is carried out through the second signal path when the level of the received signal is higher than the first threshold. More specifically, the level of the received signal is once attenuated by the antenna damping circuit 4 included in the second signal path and is then amplified by a necessary quantity through the second LNA 5 so that the gain of the received signal is controlled in a total of the attenuation and the amplification.

Therefore, a level of a signal input to the second LNA 5 is comparatively low. Even if the signal is amplified, a distortion of the signal occurs with difficulty. consequently, in the case in which the AGC starting level is increased to inhibit the suppression in a sensitivity, it is possible to suppress a deterioration in a distortion characteristic when a received signal having a high level is input. Thus, it is possible to cause an improvement in the suppression in a sensitivity and an improvement in the distortion characteristic to be compatible with each other.

### Second Embodiment

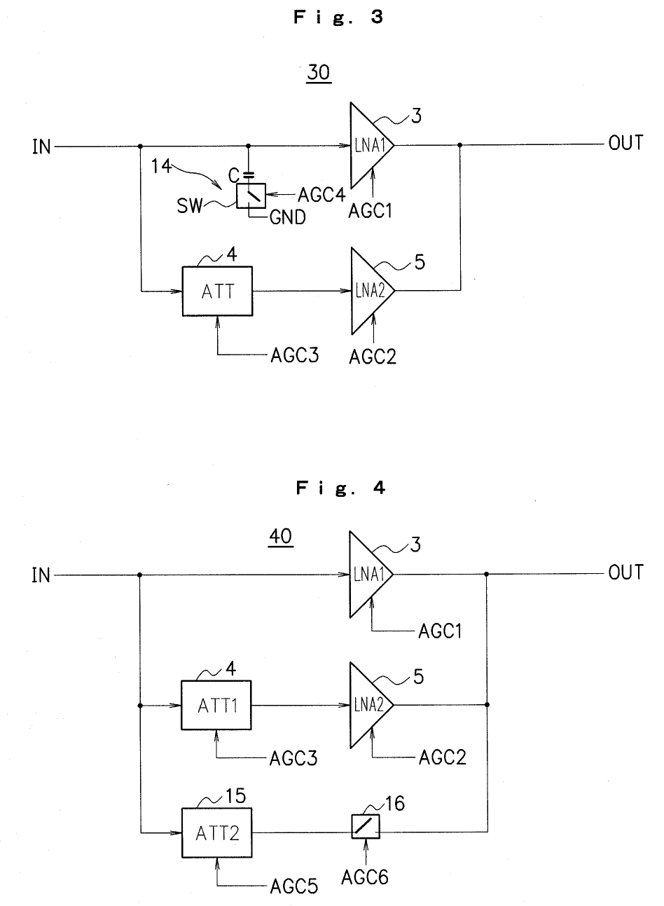

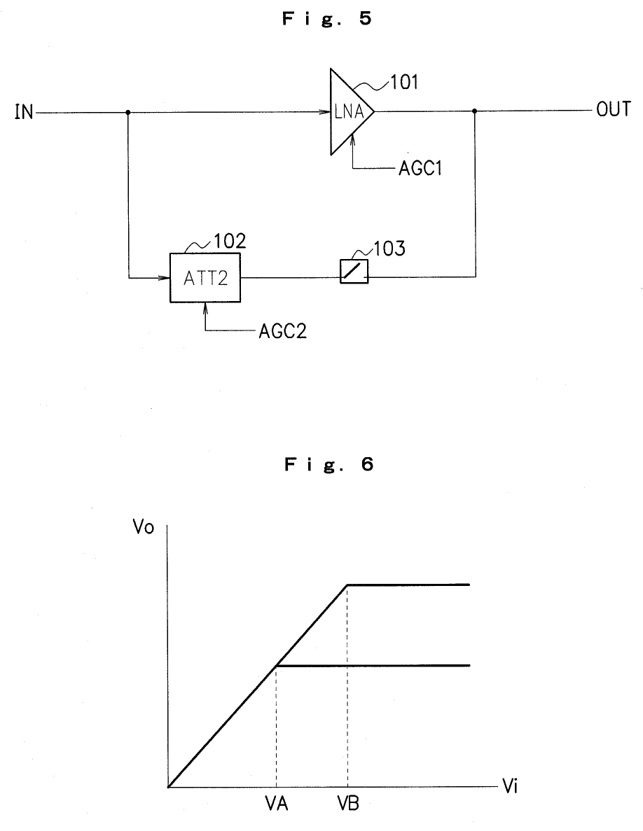

Next, a second embodiment according to the present invention will be described with reference to the drawings. FIG. 3 is a diagram showing an example of a structure of an RF-AGC circuit 30 according to the second embodiment. The RF-AGC circuit 30 is used in place of the RF-AGC circuit 20 in the radio receiver shown in FIG. 1.

As shown in FIG. 3, the RF-AGC circuit 30 according to the second embodiment includes a fixed attenuating circuit 14 in addition to a first LNA 3, an antenna damping circuit 4 and a second LNA 5. The fixed attenuating circuit 14 attenuates a radio frequency signal passing through a BPF 2 by a fixed quantity of an attenuation and is connected to an input stage of the first LNA 3 (between the BPF 2 and the first LNA 3). More specifically, a first signal path is constituted by the fixed attenuating circuit 14 and the first LNA 3.

The fixed attenuating circuit 14 is constituted by a capacitor C and a switch SW which are connected in series between a node corresponding to an input stage of the first LNA 3 and a ground GND. The switch SW is controlled to be turned OFF when the first LNA 3 is ON and to be turned ON when the first LNA 3 is OFF based on a fourth AGC signal supplied from an interface circuit 13.

When the first LNA 3 is OFF, an element itself constituting the first LNA 3 is not operated. When a signal having a high level is applied to the first LNA 3, however, the element is slightly influenced by a distortion. By providing the fixed attenuating circuit 14 in a former stage of the first LNA 3 to attenuate a level of a received signal, therefore, it is possible to further improve a distortion characteristic.

### Third Embodiment

Next, a third embodiment according to the present invention will be described with reference to the drawings. FIG. 4 is a diagram showing an example of a structure of an RF-AGC circuit 40 according to the third embodiment. The RF-AGC circuit 40 is used in place of the RF-AGC circuit 20 in the radio receiver shown in FIG. 1.

As shown in FIG. 4, the RF-AGC circuit 40 according to the third embodiment includes a second antenna damping circuit 15 and a bypass switch 16 in addition to a first LNA 3, an antenna damping circuit 4 and a second LNA 5. The second antenna damping circuit 15 corresponds to a second variable attenuating circuit according to the present invention and controls a radio frequency signal passing through a BPF 2 to have a degree of an attenuation which is variably set based on a fifth AGC signal. The bypass switch 16 is connected in series to the second antenna damping circuit 15 and is turned ON/OFF in response to a sixth AGC control signal supplied from an interface circuit 13.

A third signal path is formed by a series circuit of the second antenna damping circuit 15 and the bypass switch 16. More specifically, the RF-AGC circuit 40 according to the third embodiment has a first signal path including the first LNA 3, a second signal path including the antenna damping circuit 4 and the second LNA 5, and the third signal path including the second antenna damping circuit 15 and the bypass switch 16, and is constituted by connecting them in parallel.

In the third embodiment, a gain of a received signal is controlled by using the first signal path when a level of a received signal detected by a DSP 12 is equal to or lower than a first threshold, using the second signal path when the level of the received signal is higher than the first threshold and is equal to or lower than a second threshold, and using the third signal path when the level of the received signal is higher than the second threshold.

When the level of the received signal is equal to or higher than the second threshold and is very high, thus, there is provided the third signal path for controlling the gain of the received signal through only an attenuation of the second antenna damping circuit 15. Consequently, it is possible to suppress an occurrence of a distortion with a signal amplification in the LNA more effectively and to further improve a distortion characteristic.

Although the description has been given to the example in which the third signal path is added to the structure of the RF AGC circuit 20 shown in FIG. 1, it is also possible to add the third signal path to the structure of the RF-AGC circuit 30 shown in FIG. 3.

While the description has been given to the example in which the level of the intermediate frequency signal of the broad band including both the desirable wave and the disturbing wave is detected as the level of the received signal and the AGC operation is controlled corresponding to the detected level in the first to third embodiments, the present invention is not restricted thereto. For example, it is also possible to detect a level of an intermediate frequency signal of a narrow band including only the desirable wave as the level of the received signal in addition to the level of the intermediate frequency signal of the broad band and to control the AGC operation corresponding to the detected levels.

In the first embodiment, for example, even if the level of the intermediate frequency signal of the broad band is equal to or higher than the first threshold, it is also possible to carry out the AGC operation by using the first signal path so as to prevent the level of the desirable wave from being further reduced through the attenuating operation of the antenna damping circuit 4, resulting in a deterioration in the receiving sensitivity when the level of the intermediate frequency signal of the narrow band (the level of the desirable wave) is equal to or lower than a predetermined threshold.

In addition, all of the embodiments are only illustrative for a materialization to carry out the present invention and the technical range of the present invention should not be thereby construed to be restrictive. More specifically, the present invention can be carried out in various forms without departing from the spirit or main features thereof.

### INDUSTRIAL APPLICABILITY

The present invention is useful for an automatic gain control circuit including a radio frequency amplifying circuit and an attenuating circuit which have variable gains. The automatic gain control circuit can be applied to a wireless communicating apparatus such as a radio receiver, a television receiver or a portable telephone.

What is claimed is:

1. An automatic gain control circuit comprising:
a first radio frequency amplifying circuit for amplifying a received radio frequency signal with a gain which is variably set based on a control signal;
a variable attenuating circuit for controlling the received radio frequency signal to have a degree of an attenuation which is variably set based on a control signal; and
a second radio frequency amplifying circuit connected in series to the variable attenuating circuit and amplifying a radio frequency signal output from the variable attenuating circuit with a gain which is variably set based on a control signal,
wherein a first signal path including the first radio frequency amplifying circuit and a second signal path including the variable attenuating circuit and the second radio frequency amplifying circuit are connected in parallel, and
a gain of the received radio frequency signal is controlled by using the first signal path when a level of the received radio frequency signal is equal to or lower than a predetermined threshold and using the second signal path when the level of the received radio frequency signal is higher than the predetermined threshold.

2. The automatic gain control circuit according to claim 1, further comprising a fixed attenuating circuit for attenuating the received radio frequency signal by a fixed quantity of an attenuation in an input stage of the first radio frequency amplifying circuit,
a first signal path including the fixed attenuating circuit and the first radio frequency amplifying circuit and a second signal path including the variable attenuating circuit and the second radio frequency amplifying circuit being connected in parallel.

3. The automatic gain control circuit according to claim 1, further comprising a second variable attenuating circuit for controlling the received radio frequency signal to have a degree of an attenuation which is variably set based on a control signal; and
a bypass switch connected in series to the second variable attenuating circuit,
wherein a first signal path including the first radio frequency amplifying circuit, a second signal path including the variable attenuating circuit and the second radio frequency amplifying circuit and a third signal path including the second variable attenuating circuit and the bypass switch are connected in parallel, and
a gain of the received radio frequency signal is controlled by using the first signal path when a level of the received radio frequency signal is equal to or lower than a first threshold, using the second signal path when the level of the received radio frequency signal is higher than the first threshold and is equal to or lower than a second threshold and using the third signal path when the level of the received radio frequency signal is higher than the second threshold.

4. The automatic gain control circuit according to claim 2, further comprising a second variable attenuating circuit for controlling the received radio frequency signal to have a degree of an attenuation which is variably set based on a control signal; and
a bypass switch connected in series to the second variable attenuating circuit,
wherein a first signal path including the fixed attenuating circuit and the first radio frequency amplifying circuit, a second signal path including the variable attenuating circuit and the second radio frequency amplifying circuit and a third signal path including the second variable attenuating circuit and the bypass switch are connected in parallel.

5. The automatic gain control circuit according to claims 1, wherein each of the first radio frequency amplifying circuit and the second radio frequency amplifying circuit includes an MOS transistor to be operated as an amplifier for amplifying an input signal; and
an MOS transistor for carrying out a control to turn ON/OFF a current path of the amplifier.
